(19) United States
(12) Patent Application Publication
(10) Pub. No.: US 2017/0088007 A1
(43) Pub. Date: Mar. 30, 2017

(54) External Auxiliary Thermal Management System for an Electric Vehicle

(71) Applicant: ATIEVA, INC., Menlo Park, CA (US)

(72) Inventors: Roberto Melendez, Menlo Park, CA (US); Adam Kasprzyk, Fremont, CA (US)

(73) Assignee: ATIEVA, INC., Menlo Park, CA (US)

(21) Appl. No.: 14/865,023

(22) Filed: Sep. 25, 2015

(51) Int. Cl. B60L 11/18; F25B 49/02; H01M 10/42; H01M 10/625; H01M 10/613

(52) U.S. Cl. CPC B60L 11/1874; H01M 10/625; H01M 10/613; H01M 10/425; F25B 49/02; B60L 11/1824; H01M 2010/4271

(57) ABSTRACT

An auxiliary thermal management system is provided that can be used to supplement an electric vehicle's on-board thermal management system during charging, thereby allowing a fast charging system to be used without adding weight or taking up packaging volume in the EV. The auxiliary system is configured to allow it to be coupled, for example using quick-disconnect couplings, to thermal conduits within the vehicle's battery pack.

### FIELD OF THE INVENTION

The present invention relates generally to an electric vehicle and, more particularly, to an external battery pack thermal management system that may be used to enhance vehicle charging.

### BACKGROUND OF THE INVENTION

In response to the demands of consumers who are driven both by ever-escalating fuel prices and the dire consequences of global warming, the automobile industry is slowly starting to embrace the need for ultra-low emission, high efficiency cars. While some within the industry are attempting to achieve these goals by engineering more efficient internal combustion engines, others are incorporating hybrid or all-electric drive trains into their vehicle line-ups. To meet consumer expectations, however, the automobile industry must not only achieve a greener drive train, but must do so while maintaining reasonable levels of performance, range, reliability, safety and cost.

The most common approach to achieving a low emission, high efficiency car is through the use of a hybrid drive train in which an internal combustion engine (ICE) is combined with one or more electric motors. While hybrid vehicles provide improved gas mileage and lower vehicle emissions than a conventional ICE-based vehicle, due to their inclusion of an internal combustion engine they still emit harmful pollution, albeit at reduced levels compared to conventional vehicles. Additionally, due to the inclusion of both an internal combustion engine and an electric motor(s) with its accompanying battery pack, the drive train of a hybrid vehicle is typically much more complex than that of either a conventional ICE-based vehicle or an all-electric vehicle, resulting in increased cost and weight. Accordingly, several vehicle manufacturers are designing vehicles that only utilize an electric motor, or multiple electric motors, thereby eliminating one source of pollution while significantly reducing drive train complexity.

The electric drive trains used in electric vehicles (EVs) have proven to be highly reliable and capable of providing exceptional performance. Unfortunately car sales for EVs have proven to be lower than one would expect, especially given the performance and reliability of these cars. It appears that these sluggish sales are due, at least in part, to the concerns of some potential buyers regarding an EV's driving range. Range concerns are further exacerbated by the relatively complex relationship between battery lifetime and charge rate (illustrated in FIG. 1) and the effects of temperature on both charge rate and battery health. While battery engineers understand the necessity of maintaining batteries within their acceptable temperature range during storage, charging and discharging, vehicle manufacturers have found it best to downplay these complexities for fear of negative publicity, especially in light of the bias that many consumers have against EVs. Accordingly rather than educate consumers, most vehicle manufacturers adopt an approach such as limiting the charge rate to a level that is acceptable with the vehicle's existing cooling system, or increasing the cooling capabilities of the vehicle's on-board thermal management system in order to allow the vehicle to safely charge at a higher rate. Unfortunately the first approach limits charge rate, thereby increasing charge time, while the second approach increases vehicle weight, lowers the available volume for passengers and cargo, and increases vehicle cost. Therefore what is needed is a system that can be used to maintain optimal battery temperature while charging at high charging rates and at high ambient temperatures. The present invention provides such a system.

### SUMMARY OF THE INVENTION

The present invention provides a thermal control system for use with an electric vehicle (EV), the EV comprising a battery pack electrically connected to a propulsion motor and an on-board thermal management system thermally coupled to the battery pack. The thermal control system of the invention is comprised of an auxiliary thermal management system that is external to and independent of the EV. The auxiliary thermal management system is co-located with a battery pack charging system. The auxiliary thermal management system, which is configured to provide supplemental cooling to the battery pack during battery pack charging, is comprised of (i) a refrigerant-based thermal control loop, where the refrigerant-based thermal control loop utilizes a refrigerant; (ii) a thermal control loop utilizing a thermal transfer fluid and a fluid pump, where the thermal transfer fluid is not comprised of the refrigerant, and where the fluid pump is configured to circulate the thermal transfer fluid when the thermal control loop is coupled to the battery pack; (iii) a refrigerant-fluid heat exchanger thermally coupled to the refrigerant-based thermal control loop and thermally coupled to the thermal control loop; and (iv) a coupling system configured to temporarily thermally couple the thermal control loop to the battery pack of the EV when the battery pack is coupled to the battery pack charging system. The thermal transfer fluid may be selected from the group consisting of water and water containing an additive, where the additive may be selected from the group consisting of ethylene glycol and propylene glycol.

In one aspect, the auxiliary thermal management system may include an expansion valve, where the expansion valve in a first position decouples the refrigerant-based thermal control loop from the refrigerant-fluid heat exchanger, and where the expansion valve in a second position couples the refrigerant-based thermal control loop to the refrigerant-fluid heat exchanger. Additionally, the expansion valve may be adjustable within a range of positions extending from the first position to the second position, and where the range of positions varies a refrigerant flow rate from the refrigerant-based thermal control loop through the refrigerant-fluid heat exchanger.

In another aspect, the coupling system may be configured to connect the thermal control loop to the on-board thermal management system such that the fluid pump circulates the thermal transfer fluid through the thermal control loop and through the on-board thermal management system. The coupling system may connect the thermal control loop to the on-board thermal management system via a pair of quick-disconnect couplings. The fluid pump may be integral to the on-board thermal management system or integral to the auxiliary thermal management system.

In another aspect, the coupling system may be configured to connect the thermal control loop to a plurality of cooling conduits integrated within the battery pack such that the fluid pump circulates the thermal transfer fluid through the thermal control loop and through the plurality of cooling conduits. The coupling system may connect the thermal control loop to the plurality of cooling conduits via a pair of quick-disconnect couplings. The fluid pump may be integral to the auxiliary thermal management system.

In another aspect, the auxiliary thermal management system may include an auxiliary thermal management system controller and the on-board thermal management system may include a battery management system (BMS) controller, where the BMS controller is configured to connect to the auxiliary thermal management system controller when the thermal control loop is thermally coupled to the battery pack. The BMS controller may be configured to connect to the auxiliary thermal management system controller via a wireless or a wired connection. The auxiliary thermal management system controller may be configured to control operation of the auxiliary thermal management system based on data acquired via the BMS controller. The BMS controller may be configured to control operation of the auxiliary thermal management system via the auxiliary thermal management system controller.

In another aspect, the refrigerant-based thermal control loop may be comprised of a compressor and a condenser and a blower fan configured to force air through the condenser.

In another aspect, the auxiliary thermal management system may include a heater coupled to the thermal control loop, where the heater is configured to heat the thermal transfer fluid within the thermal control loop.

A further understanding of the nature and advantages of the present invention may be realized by reference to the remaining portions of the specification and the drawings.

### BRIEF DESCRIPTION OF THE DRAWINGS

It should be understood that the accompanying figures are only meant to illustrate, not limit, the scope of the invention and should not be considered to be to scale. Additionally, the same reference label on different figures should be understood to refer to the same component or a component of similar functionality.

FIG. 1 illustrates the relationship between charge rate and battery lifetime;

FIG. 2 provides a system level diagram of a battery management control system;

FIG. 3 provides a perspective view of a battery pack and the vehicle chassis to which it is to be mounted;

FIG. 4 illustrates an exemplary battery pack cooling system in accordance with the prior art;

FIG. 5 illustrates an alternate battery pack cooling system in accordance with the prior art;

FIG. 6 illustrates an alternate battery pack cooling system in accordance with the prior art, the illustrated system utilizing both a radiator and a heat exchanger as described relative to FIGS. 4 and 5, respectively;

FIG. 7 provides a schematic of a preferred embodiment of the invention;

FIG. 8 provides a schematic of the coolant conduits within a battery pack for use with the invention;

FIG. 9 provides a schematic of the coolant conduits within a battery pack for use with the invention;

FIG. 10 illustrates the embodiment shown in FIG. 7, modified to allow the EV's BMS controller to control operation of the auxiliary thermal management system via a wired connection;

FIG. 11 illustrates the embodiment shown in FIG. 7, modified to allow the EV's BMS controller to control operation of the auxiliary thermal management system via a wireless connection;

FIG. 12 illustrates the embodiment shown in FIG. 7, modified to include a heater within the auxiliary thermal management system;

FIG. 13 illustrates the embodiment shown in FIG. 10, modified to include a heater within the auxiliary thermal management system;

FIG. 14 illustrates the embodiment shown in FIG. 11, modified to include a heater within the auxiliary thermal management system;

FIG. 15 provides a schematic of an alternate embodiment of the invention;

FIG. 16 illustrates the embodiment shown in FIG. 15, modified to allow the EV's BMS controller to control operation of the auxiliary thermal management system via a wired connection;

FIG. 17 illustrates the embodiment shown in FIG. 15, modified to allow the EV's BMS controller to control operation of the auxiliary thermal management system via a wireless connection;

FIG. 18 illustrates the embodiment shown in FIG. 15, modified to include a heater within the auxiliary thermal management system;

FIG. 19 illustrates the embodiment shown in FIG. 16, modified to include a heater within the auxiliary thermal management system; and

FIG. 20 illustrates the embodiment shown in FIG. 17, modified to include a heater within the auxiliary thermal management system.

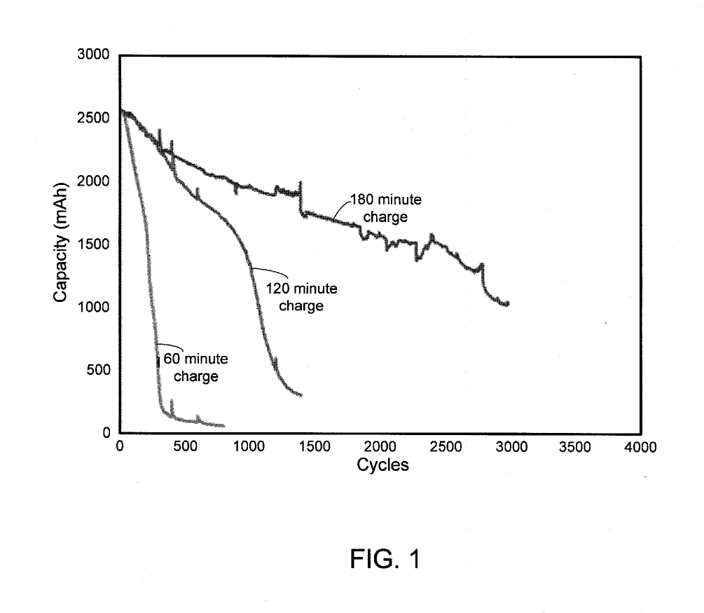

### DESCRIPTION OF THE SPECIFIC EMBODIMENTS

As used herein, the singular forms “a”, “an” and “the” are intended to include the plural forms as well, unless the context clearly indicates otherwise. The terms “comprises”, “comprising”, “includes”, and/or “including”, as used herein, specify the presence of stated features, process steps, operations, elements, and/or components, but do not preclude the presence or addition of one or more other features, process steps, operations, elements, components, and/or groups thereof. As used herein, the term “and/or” and the symbol “/” are meant to include any and all combinations of one or more of the associated listed items. Additionally, while the terms first, second, etc. may be used herein to describe various steps, calculations, or components, these steps, calculations, or components should not be limited by these terms, rather these terms are only used to distinguish one step, calculation, or component from another. For example, a first calculation could be termed a second calculation, and, similarly, a first step could be termed a second step, and, similarly, a first component could be termed a second component, without departing from the scope of this disclosure.

In the following text, the terms “battery”, “cell”, and “battery cell” may be used interchangeably and may refer to any of a variety of different battery configurations and chemistries. Typical battery chemistries include, but are not limited to, lithium ion, lithium ion polymer, nickel metal hydride, nickel cadmium, nickel hydrogen, nickel zinc, and silver zinc. The term “battery pack” as used herein refers to an assembly of one or more batteries electrically interconnected to achieve the desired voltage and capacity, where the battery assembly is typically contained within an enclosure. The terms “electric vehicle” and “EV” may be used interchangeably and may refer to an all-electric vehicle, a plug-in hybrid vehicle, also referred to as a PHEV, or a hybrid vehicle, also referred to as a HEV, where a hybrid vehicle utilizes multiple sources of propulsion including an electric drive system.

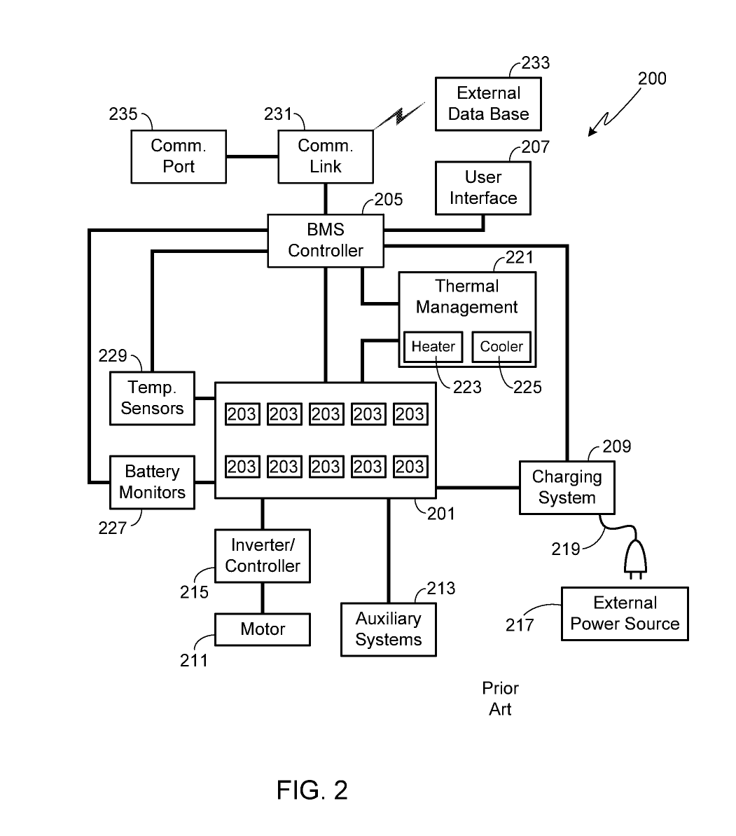

FIG. 2 provides a block diagram representing a battery management system (BMS) 200 coupled to a typical EV battery pack 201. It should be understood that the present invention is not limited to a specific battery pack configuration, mounting scheme, or battery pack size. Additionally, it should be understood that the invention is not limited to a battery pack comprised of batteries of a particular chemistry or form factor, and the battery pack may be comprised of tens, hundreds, or thousands of individual batteries connected in parallel, series, or in a series-parallel manner to yield the desired voltage and capacity (kW-h). Exemplary interconnect configurations are disclosed in co-assigned U.S. patent application Ser. No. 13/794,535, filed 11 Mar., 2013, and Ser. No. 14/203,874, filed 11 Mar. 2014, the disclosures of which are incorporated herein for any and all purposes. In at least one preferred embodiment, individual batteries are connected in series to form battery groups or modules 203, and groups/modules 203 are connected in series to form battery pack 201. In addition to being useful as a means of obtaining the desired voltage/capacity, separately packaging the groups/modules simplifies battery pack fabrication, assembly, testing and repair. Note that in order to simplify FIG. 2, individual battery and module interconnects are not shown.

A BMS, such as the one shown in FIG. 2, is designed and configured to (i) minimize battery pack degradation, i.e., the unintentional and/or rapid decrease of battery lifetime, and (ii) prevent battery abuse that may lead to a thermal runaway event, an incident that rechargeable batteries are prone to in which the battery's internal reaction rate increases to such an extent that it is generating more heat than can be withdrawn. To achieve these goals, the BMS insures that the batteries are properly charged and discharged (i.e., neither overcharged nor unnecessarily subjected to deep discharge), maintained within the desired temperature range, and monitored for short circuits and thermal runaway events.

BMS 200 includes a BMS controller 205 comprised of a microprocessor. BMS controller 205 may be independent of, or integral to, the vehicle management system. BMS controller 205 typically includes memory for storing data and processor instructions, with the memory being comprised of EPROM, EEPROM, flash memory, RAM, solid state drive, hard disk drive, or any other type of memory or combination of memory types. A user interface 207 is coupled to BMS controller 205, interface 207 providing a means for the BMS controller, either directly or via a vehicle management system, to provide information to the driver, information such as the vehicle's current driving range and the current battery capacity. Interface 207 may also be used to provide warnings to the driver, e.g., low battery capacity, reduced vehicle functionality due to low battery capacity, battery temperature exceeding desired operating range, etc. Preferably interface 207 also provides a means for the driver to control aspects of the system, for example selecting a mode of vehicle operation (e.g., performance, extended range, extended battery lifetime, etc.) and/or controlling the charging system 209 (e.g., charge rate). Assuming that interface 207 is part of the vehicle management system, the interface may also be configured for use in controlling other aspects of the vehicle such as the vehicle's navigation system, HVAC system, entertainment system (e.g., radio, CD/DVD player, etc.), and the internal/external lights. Interface 207 may be comprised of a single interface, for example a touch-screen display, or a combination of user interfaces such as push-button switches, capacitive switches, slide or toggle switches, gauges, display screens, visible and/or audible warning indicators, etc. It will be appreciated that if user interface 207 includes a graphical display as preferred, controller 205 may also include a graphical processing unit (GPU), with the GPU being either separate from or contained on the same chip set as the CPU.

Battery pack 201 supplies energy to one or more motors 211 utilized by the vehicle's drive train. Preferably battery pack 201 is also connected to the various vehicle auxiliary systems 213 that require electrical power (e.g., lights, entertainment systems, navigation system, etc.). Typically battery pack 201 is coupled to motor(s) 211 via a power control system 215 (i.e., an inverter and motor controller) that insures that the energy delivered to the drive motor(s) is of the proper form (e.g., correct voltage, current, waveform, etc.).

Charging system 209 may be integrated into the vehicle as preferred, or it may be external to the vehicle. Charging system 209 is configured to be electrically connected to an external source 217, such as a municipal power grid, typically by using a power cord 219. In at least one configuration, charging system 209 is wirelessly connected to external source 217, for example using an inductive charging pad over which the EV is parked. Battery pack 201 may also be charged, at least in part, using an on-board charging system such as a regenerative braking system.

BMS controller 205 controls an on-board thermal management system 221 that includes both a heating subsystem 223 and a cooling subsystem 225. Thermal management system 221 is used by BMS controller 205 to insure that the batteries within battery pack 201 are maintained within the batteries' desired operating temperature range. When system 221 is used to control the temperature of battery pack 201, the system may utilize heated or cooled air, circulating the heated or cooled air throughout the battery pack; alternately, a coolant circulation system may be thermally coupled to the battery pack, where the coolant is heated by heater 223 or cooled by cooler 225 as required.

BMS controller 205 is also coupled to a variety of sensor systems, thus allowing it to monitor battery pack performance/health and make adjustments as necessary. For example, controller 205 is coupled to sensors 227 that allow the battery pack to be characterized, e.g., state-of-charge (SOC) and/or state-of-energy (SOE), battery/module voltage, etc. Sensors 227 may also be used to collect battery and battery pack data such as charging frequency, charging level, and charge rate. Controller 205 is also coupled to temperature sensors 229 that monitor the temperature of battery pack 201, for example during charging, discharge (i.e., use) and storage. The temperature data acquired via sensors 229 allows the controller to make adjustments to thermal management system 221, thus insuring that the batteries remain within the desired temperature range. Temperature sensors 229 may monitor battery temperature at the individual battery level; alternately, battery temperature may be monitored for a group of batteries, for example batteries mounted within the pack in close proximity to one another; alternately, battery temperature may be based on the temperature of the thermal transfer fluid (e.g., coolant) used by thermal management system 221 to control battery pack temperature; alternately, battery temperature may be based on the temperature of the air exiting the battery pack. It should be understood that other techniques may be used to monitor battery/battery pack temperature and the invention is not limited to a specific technique.

Preferably BMS controller 205 is also coupled to a communication link 231 that may be used to obtain system and/or configuration updates, transmit battery pack data to the vehicle's manufacturer, etc. As such, communication link 231 may be used to provide a communication link between the BMS controller 205 and an external data source (e.g., manufacturer, dealer, service center, web-based application, remote home-based system, third party source, etc.) and/or access an external data base 233, for example a data base maintained by the car's manufacturer or a third party. Link 231 may use any of a variety of different technologies (e.g., GSM, EDGE, UMTS, CDMA, DECT, WiFi, WiMax, etc.). Communication link 231 may also include an on-board port 235, such as a USB, Thunderbolt, or other port, thus allowing wired communication between BMS controller 205 and an external data base or system.

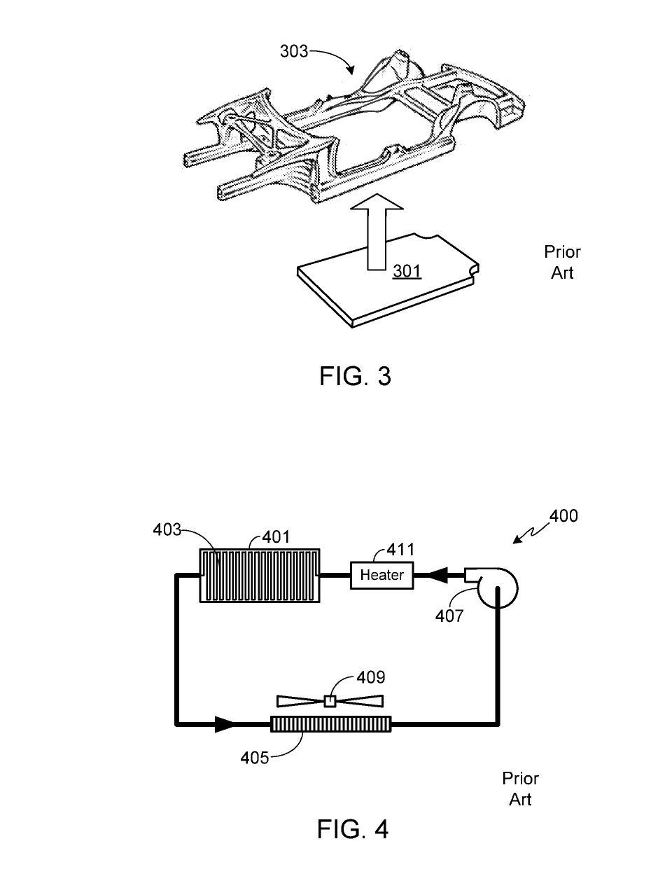

As previously noted, the present invention is not limited to a specific battery pack mounting scheme, battery pack size, or battery pack configuration, nor is the present invention limited to a specific on-board thermal management system. FIG. 3 provides a perspective view of an exemplary battery pack configuration in which the battery pack 301 is mounted under vehicle chassis 303. FIGS. 4-6 illustrate some common on-board thermal management systems. Other exemplary on-board thermal management systems are shown in co-assigned U.S. patent application Ser. No. 14/148,933, filed 7, Jan. 2014, Ser. No. 14/340,606, filed 25, Jul. 2014, Ser. No. 14/519,182, filed 21, Oct. 2014, and Ser. No. 14/698,394, filed 28, Apr. 2015, the disclosures of which are incorporated herein for any and all purposes.

FIG. 4 illustrates an exemplary battery thermal management system 400 in accordance with the prior art. In system 400, the temperature of the batteries within battery pack 401 is controlled by pumping a thermal transfer medium, e.g., a liquid coolant, through a plurality of cooling conduits 403 integrated into battery pack 401. Conduits 403, which are fabricated from a material with a relatively high thermal conductivity, are positioned within pack 401 in order to optimize thermal communication between the individual batteries, not shown, and the conduits, thereby allowing the temperature of the batteries to be regulated by regulating the flow of coolant within conduits 403 and/or regulating the transfer of heat from the coolant to another temperature control system. In the illustrated embodiment, the coolant within conduits 403 is pumped through a radiator 405 using a pump 407. A blower fan 409 may be used to force air through radiator 405, for example when the car is stationary or moving at low speeds, thus insuring that there is an adequate transfer of thermal energy from the coolant to the ambient environment. System 400 may also include a heater 411, e.g., a PTC heater, that may be used to heat the coolant within conduits 403, and thus heat the batteries within pack 401.

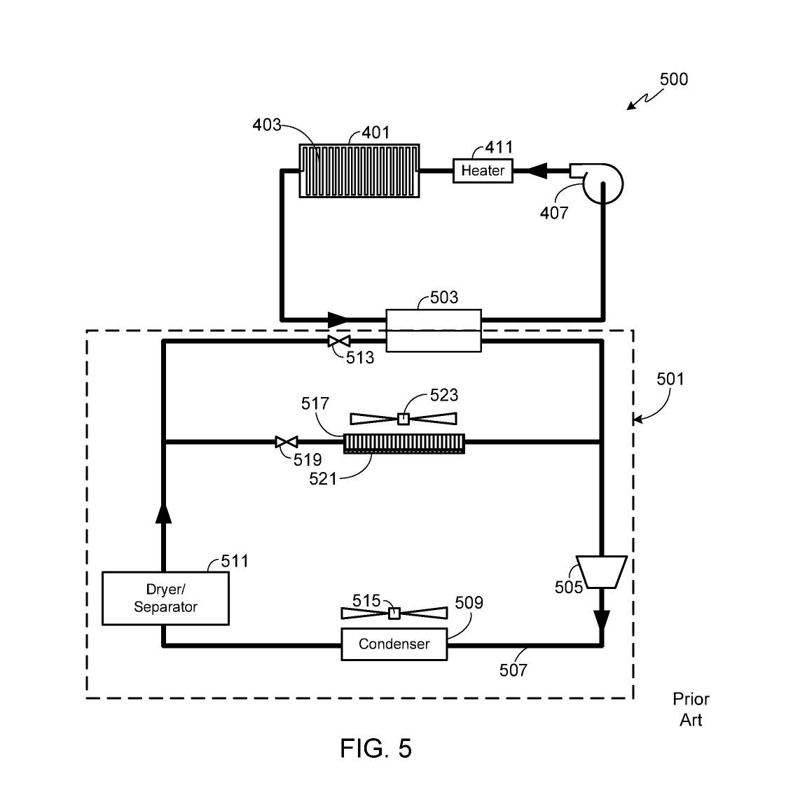

FIG. 5 illustrates an alternate battery pack thermal management system 500. In system 500 the coolant within conduits 403 is coupled to a secondary thermal management system 501 via a heat exchanger 503. Preferably thermal management system 501 is a refrigeration system and as such, includes a compressor 505 to compress the low temperature vapor in refrigerant line 507 into a high temperature vapor and a condenser 509 in which a portion of the captured heat is dissipated. After passing through condenser 509, the refrigerant changes phases from vapor to liquid, the liquid remaining at a temperature below the saturation temperature at the prevailing pressure. Preferably the refrigerant also passes through a dryer 511 (also referred to as a receiver/dryer, filter/dryer, dryer/separator, and/or receiver/dehydrator) that removes moisture from the condensed refrigerant. After dryer 511, refrigerant line 507 is coupled to heat exchanger 503 via a thermal expansion valve 513 which controls the flow rate of refrigerant into heat exchanger 503. Additionally, in the illustrated system a blower fan 515 is used in conjunction with condenser 509 to improve system efficiency.

In a typical vehicle configuration, thermal management system 501 is also coupled to the vehicle's heating, ventilation and air conditioning (HVAC) system. In such a system, in addition to coupling refrigerant line 507 to heat exchanger 503, line 507 may also be coupled to the HVAC evaporator 517. A thermal expansion valve 519 is preferably used to control refrigerant flow rate into the evaporator. A heater, for example a PTC heater 521 integrated into evaporator 517, may be used to provide warm air to the passenger cabin. In a conventional HVAC system, one or more fans 523 are used to circulate air throughout the passenger cabin, where the circulating air may be ambient air, air cooled via evaporator 517, or air heated by heater 521.

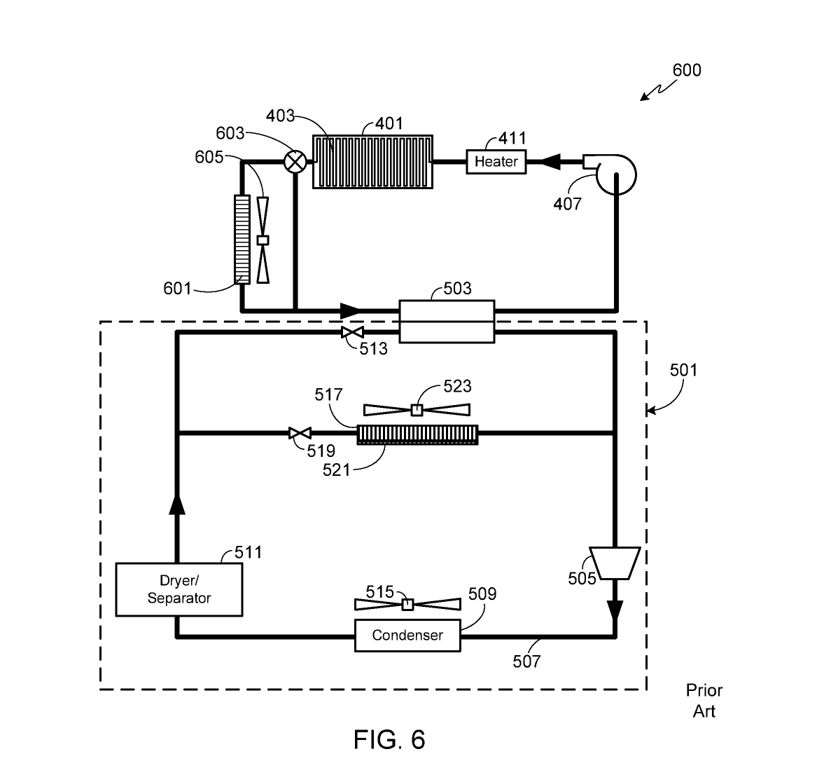

In some electric vehicles, battery pack cooling is accomplished using a combination of a radiator such as that shown in FIG. 4, and a heat exchanger such as that shown in FIG. 5. FIG. 6 illustrates such a conventional cooling system. In system 600, the coolant passing through battery pack 401 via conduits 403 may be directed through either radiator 601 or heat exchanger 503. Valve 603 controls the flow of coolant through radiator 601. Preferably a blower fan 605 is included in system 600 as shown, thus providing means for forcing air through the radiator when necessary, for example when the car is stationary.

As previously discussed, preferably an EV's on-board thermal management system is no larger than necessary to maintain the batteries within their preferred temperature range under a wide variety of driving conditions and ambient temperatures. By not oversizing the thermal management system, it does not contribute unnecessarily to the weight of the EV, nor does it require more packaging volume than necessary. Unfortunately such an on-board thermal management system is typically inadequate to cool the batteries during charging at high current levels, thus preventing EVs with a standard-sized (i.e., non-oversized) cooling system from utilizing a fast charging system.

The present invention overcomes the limitations noted above by providing additional cooling capabilities during charging, thereby allowing an EV with a standard-sized on-board thermal management system to utilize a fast charging, i.e., high current, system. The additional cooling capabilities of the invention are separate from the on-board thermal management system, thus not adding weight or taking up packaging volume in the EV. It should be understood that the auxiliary thermal management system of the invention is only meant to supplement the on-board thermal management system and as such, it is expected that the auxiliary system would only be used when the capabilities of the on-board system are insufficient due to the desired charge rate, and thus the temperature generated during charging, or when ambient temperatures are excessive.

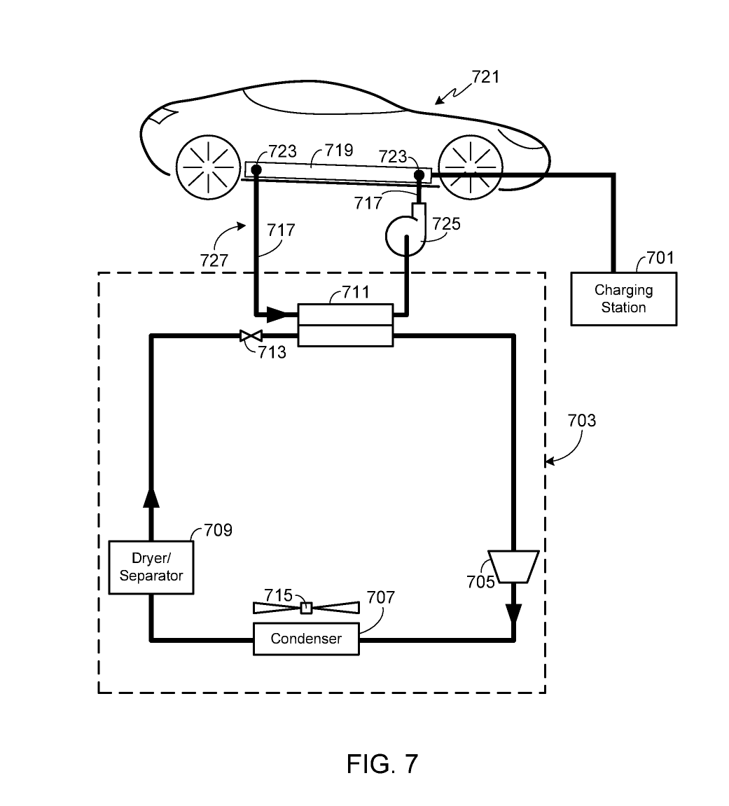

FIG. 7 provides a schematic of a preferred embodiment of the invention. As shown, co-located with a charging station 701 is an auxiliary thermal management system 703. At a minimum, thermal management system 703 includes a cooling system. Preferably the cooling system is a refrigeration system that includes a compressor 705, a condenser 707, a dryer 709 and a heat exchanger 711. A thermal expansion valve 713 controls the flow rate of refrigerant into heat exchanger 711. Preferably a blower fan 715 is used in conjunction with condenser 707 to improve system efficiency.

A coolant line 717 couples heat exchanger 711 to the cooling conduits within battery pack 719 of EV 721. A coolant pump 725 circulates the coolant through thermal control loop 727, more specifically through cooling conduits 717, heat exchanger 711 and the cooling conduits within battery pack 719. Coolant pump 725 may be integral to auxiliary thermal management system 703; alternately, coolant pump 725 may be integral to the EV's on-board thermal management system. Preferably the coolant, i.e., heat transfer fluid, contained in coolant line 717 is water-based, e.g., pure water or water that includes an additive such as ethylene glycol or propylene glycol, although a non-water-based, heat transfer fluid may also be used in coolant line 717.

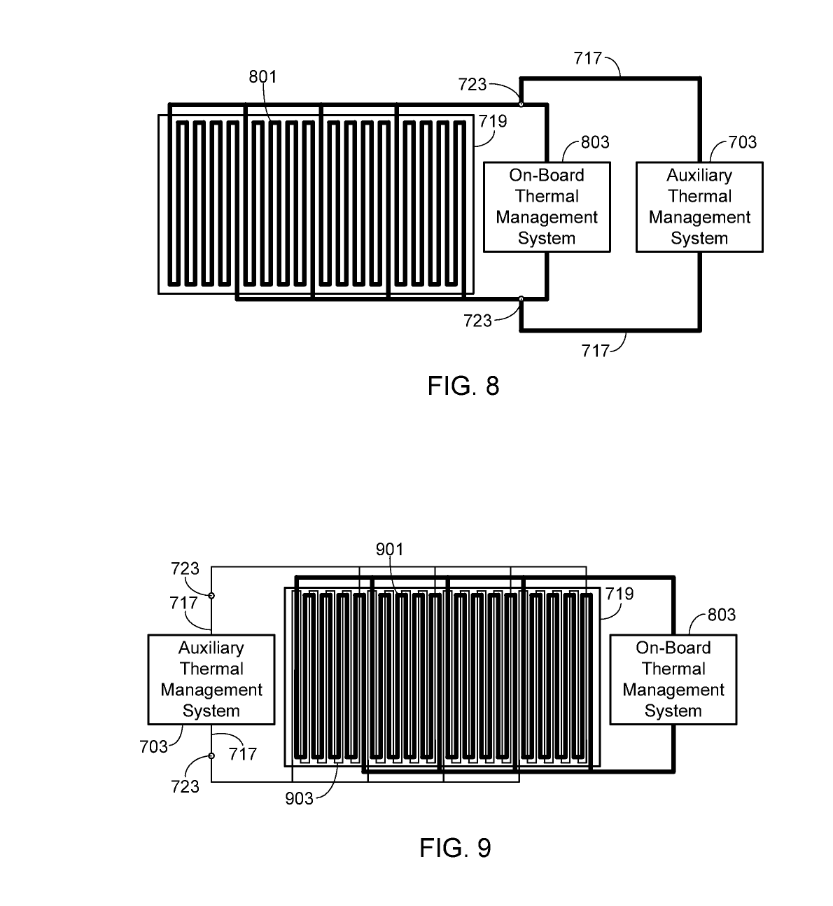

Coolant line 717 is preferably coupled to the cooling conduits within battery pack 719 via quick disconnect couplings 723, thus simplifying their use by the EV's operator. Preferably and as illustrated in FIG. 8, quick disconnect couplings 723 allow the coolant lines 717 to be coupled to the same set of battery pack cooling conduits 801 used by the on-board thermal management system 803. Alternately and as illustrated in FIG. 9, battery pack 719 may include two or more sets of cooling conduits, thus allowing one set of cooling conduits 901 to be dedicated to the on-board thermal management system 803, and a second set of cooling conduits 903 to be dedicated to the auxiliary thermal management system 703. It should be understood that the geometry and configuration of the battery pack's cooling conduits shown in the exemplary embodiments shown in FIGS. 8 and 9 are only meant to illustrate some common conduit configurations and that the invention is not limited to these configurations. For example, the inventors envision that the cooling conduits may be mounted beneath, above or adjacent to the batteries within the battery pack and may utilize any of a variety of coolant manifold configurations.

A charging station that includes the auxiliary thermal management system of the invention may be configured in a variety of ways. For example, the system may be configured such that the EV's operator, or a third party, plugs EV 721 into the charging station 701 and then connects auxiliary thermal management system 703 to the cooling conduits of the battery pack 719 via couplings 723, which are preferably quick disconnect couplings. Alternately, the EV's operator, or a third party, may first connect auxiliary thermal management system 703 to the cooling conduits of the battery pack 719 via couplings 723 and then plug the EV into charging station 701. Alternately, the EV operator may not require fast charging and as such, may only plug the vehicle into charging station 701, foregoing the need for auxiliary cooling.

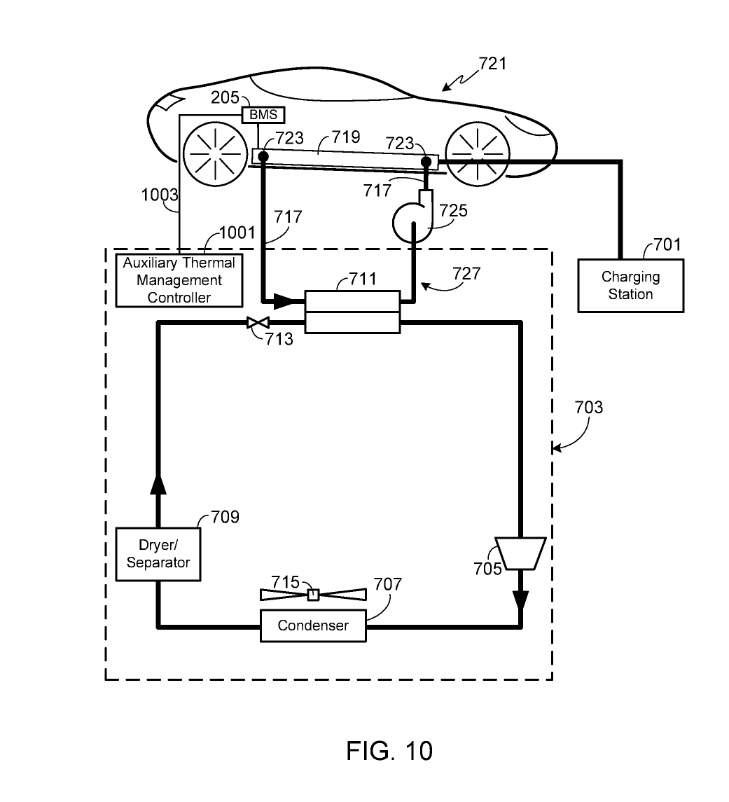

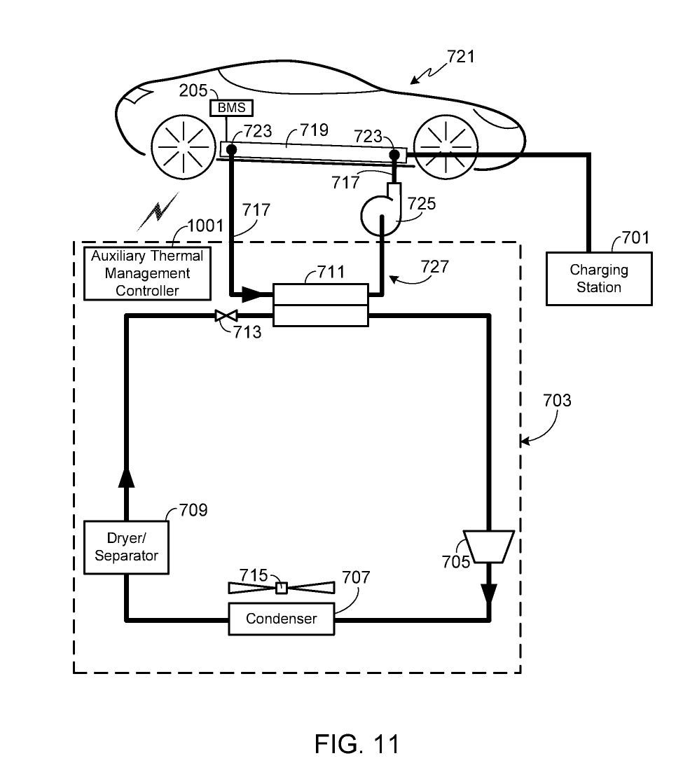

The degree to which auxiliary cooling is needed during charging varies based on a variety of factors that include the ambient temperature (e.g., the temperature at the charging site), the ambient temperature of the battery pack, the intended charge rate, the configuration of the battery pack, the configuration of the on-board thermal management system (e.g., the extent to which the on-board thermal management system is used during charging), the electrical characteristics of the battery pack (e.g., type of battery, battery pack capacity, etc.), etc. As such, in the preferred embodiment of the invention the BMS controller (e.g., BMS controller 205) controls operation of the auxiliary thermal management system 703. Alternately, the auxiliary thermal management system's controller may utilize battery pack information (e.g., battery temperature) obtained from the EV's BMS controller to operate the auxiliary cooling system. The auxiliary thermal management system's controller 1001 may be plugged into the EV's BMS controller via communication line 1003 as shown in FIG. 10, for example utilizing communication port 235 or a dedicated port. Alternately, the auxiliary thermal management system's controller may wirelessly communicate with the EV's BMS controller as shown in FIG. 11, for example utilizing communication link 231 or a dedicated communication link.

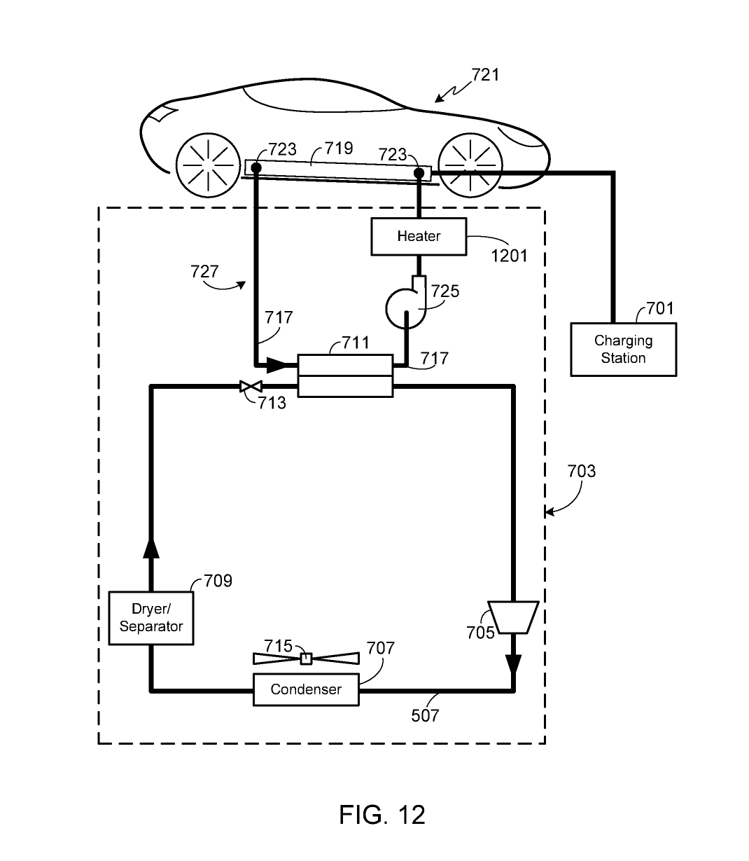

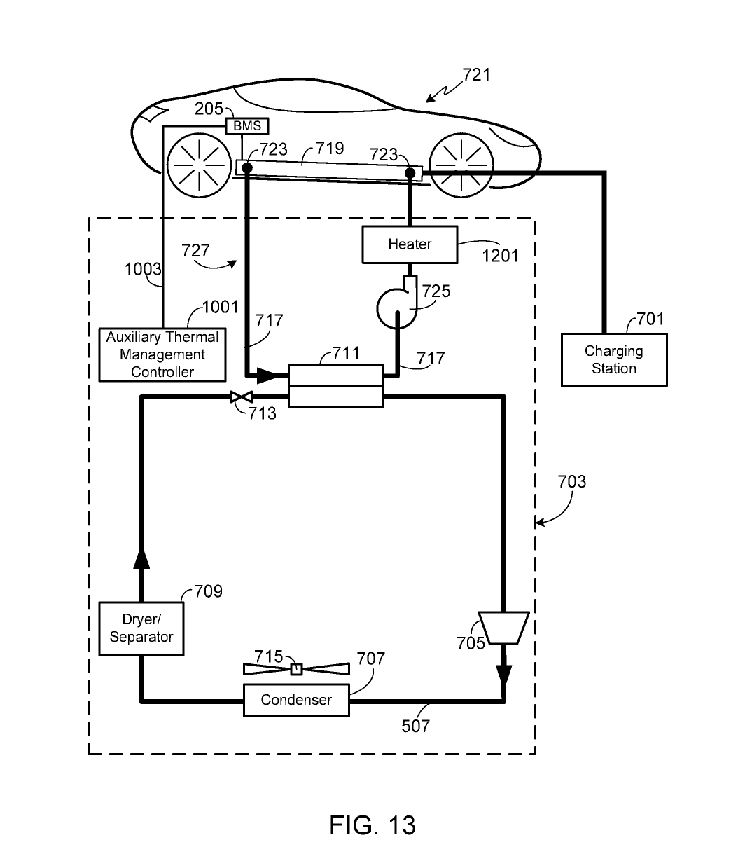

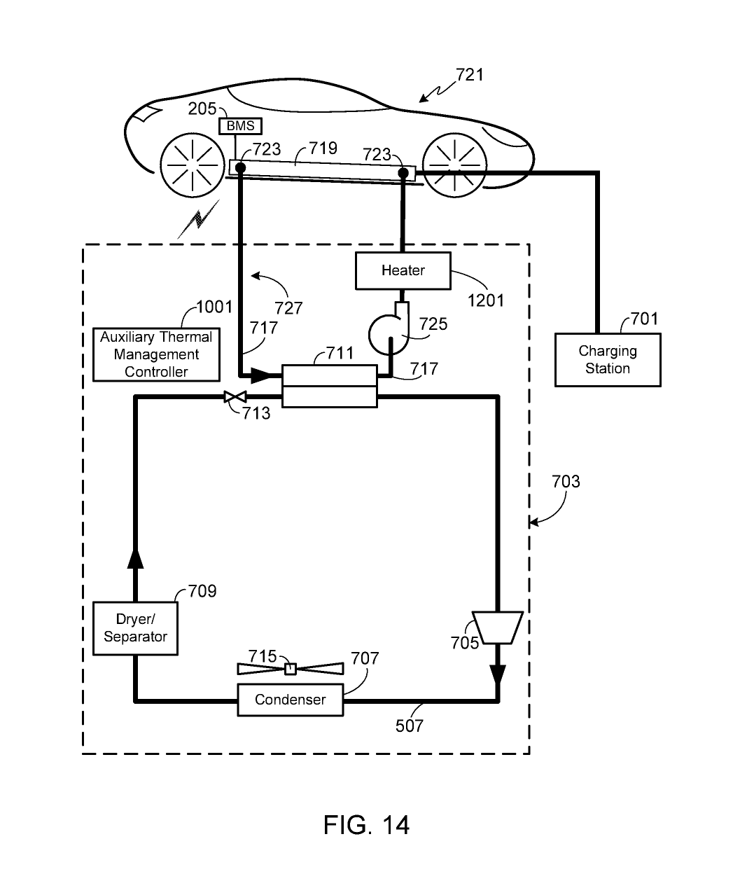

In some instances it may be necessary to heat the batteries prior to, or concurrently with, battery charging. For example, if the car and battery pack are at ambient temperature, and the ambient environmental temperature is quite low, the batteries may charge more efficiently at a higher temperature. It should be understood that the need for battery heating depends on a variety of factors including the battery chemistry, the desired charge rate, and the battery pack temperature. FIGS. 12-14 illustrate three configurations of the invention, based on the configurations shown in FIGS. 7, 10 and 11, in which the auxiliary thermal management system includes a heater 1201 that may be used to heat the coolant within conduits 717, and thus heat the batteries within pack 719.

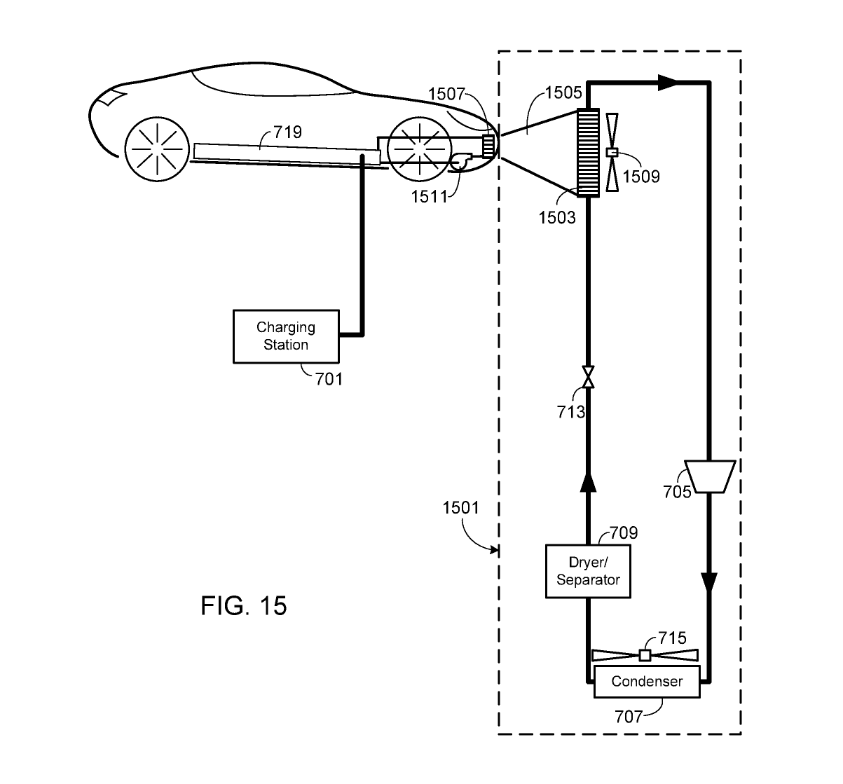

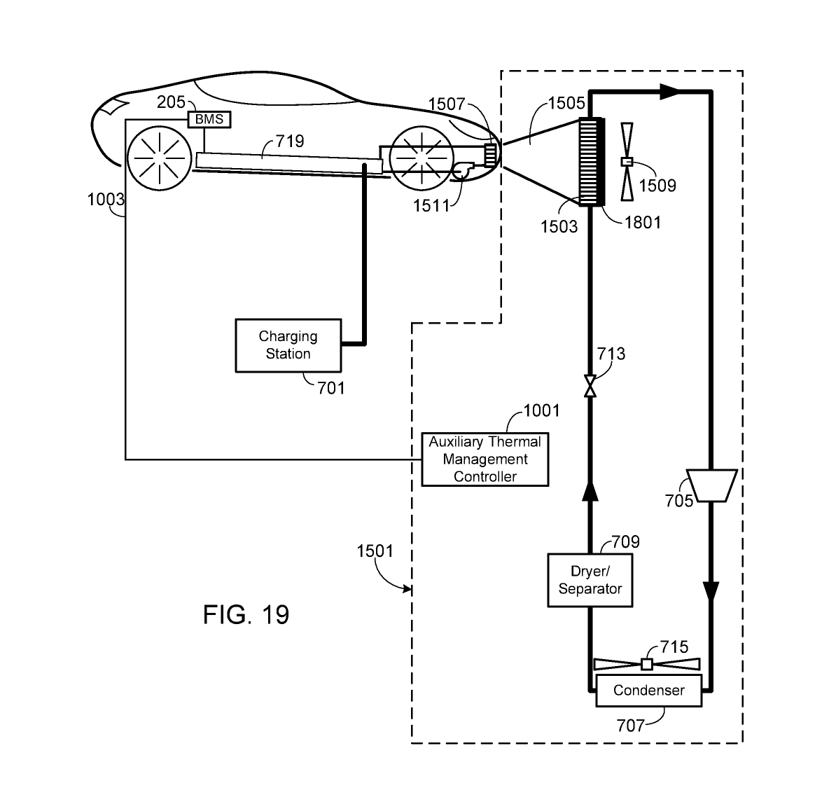

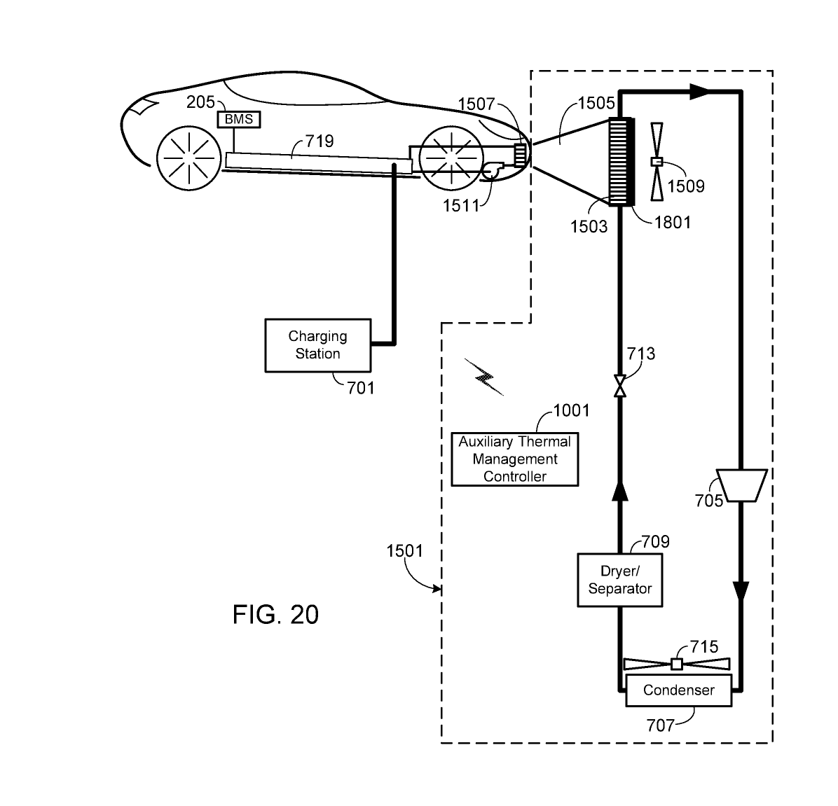

While the embodiments described above provide an efficient means of cooling, and/or heating, the battery pack of an EV with an auxiliary thermal management system, these embodiments require the EV to be fitted with means to connect the EV's battery pack to the auxiliary thermal management system, e.g., couplings 723, and utilize either the cooling conduits employed by the on-board thermal management system or utilize a second set of cooling conduits that are configured to be coupled to the auxiliary thermal management system. In order to overcome this limitation, in a second set of embodiments illustrated in FIGS. 15-20 the auxiliary thermal management system is not coupled to cooling conduits within the EV's battery pack. Rather, in these embodiments the auxiliary system is used to cool, or heat, air that is then forced through the radiator of the on-board thermal management system. This approach allows a wide range of EVs to utilize the auxiliary thermal management system by simply driving up to the charging station and adjusting the air duct so that the cooled, or heated, air is directed through the on-board heat exchanger.

In the auxiliary thermal management system 1501 shown in FIG. 15, the refrigerant to coolant heat exchanger 711 of auxiliary thermal management system 703 is replaced with a refrigerant to air heat exchanger 1503. In order to achieve adequate thermal transfer efficiency, a duct 1505 couples the output of heat exchanger 1503 to the input of the EV's on-board air to coolant heat exchanger 1507 (i.e., a radiator) used by the on-board thermal management system, e.g., heat exchanger 405 in FIG. 4 or heat exchanger 601 in FIG. 6. A fan 1509 forces air through the auxiliary heat exchanger 1503 and through the on-board heat exchanger 1507 via duct 1505. An on-board pump 1511 (e.g., pump 407 shown in FIGS. 4-6) circulates the battery coolant cooled, or heated, via the auxiliary system through the EV's radiator and battery pack. Preferably duct 1505 is easily adjusted in order to accommodate a variety of vehicles and vehicle radiator configurations.

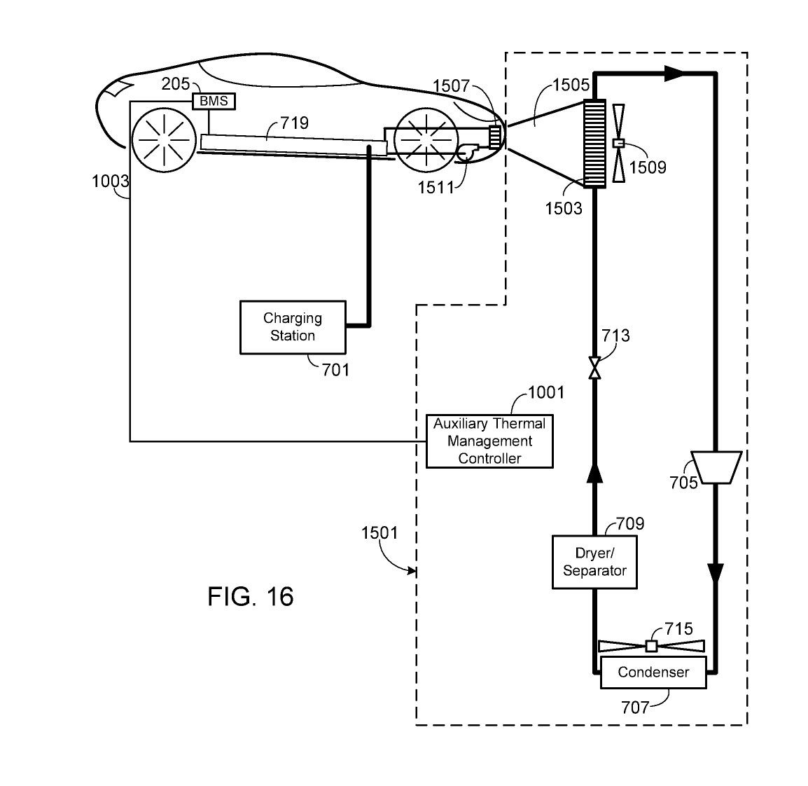

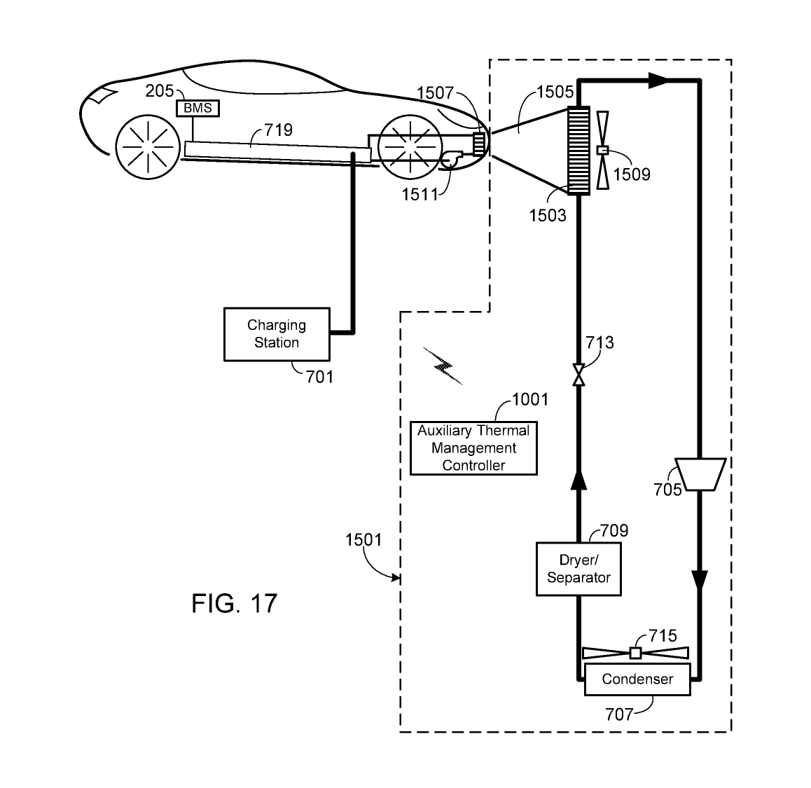

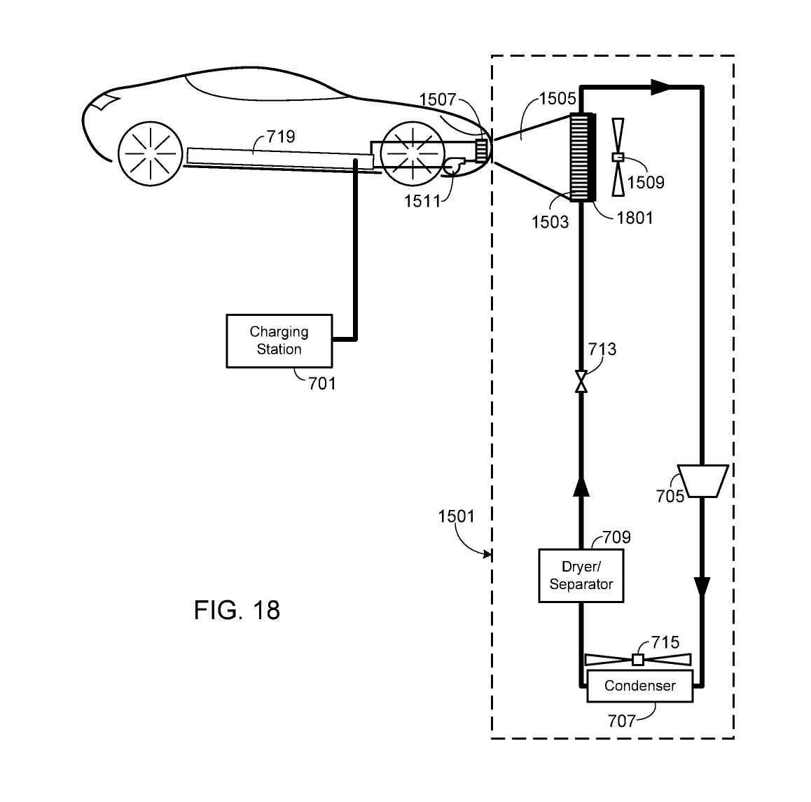

Although not required, preferably the on-board BMS controller 205 controls the auxiliary system. For example, controller 205 may control expansion valve 713 in order to vary the cooling supplied by the system; and/or controller 205 may control heater 1801 in order to vary the heating supplied by the system; and/or controller 205 may control the speed of blower fan 1509. BMS controller 205 may communicate with the auxiliary controller 1001 via either a wired connection as shown in FIG. 16 or a wireless connection as shown in FIG. 17. Preferably an auxiliary heater 1801 is included in the auxiliary thermal management system, thereby allowing heated air to be forced through the on-board radiator, thus allowing the battery pack to be heated when needed. FIGS. 18-20 illustrate three configurations of the invention, based on the configurations shown in FIGS. 15-17, in which the auxiliary thermal management system includes heater 1801.

Systems and methods have been described in general terms as an aid to understanding details of the invention. In some instances, well-known structures, materials, and/or operations have not been specifically shown or described in detail to avoid obscuring aspects of the invention. In other instances, specific details have been given in order to provide a thorough understanding of the invention. One skilled in the relevant art will recognize that the invention may be embodied in other specific forms, for example to adapt to a particular system or apparatus or situation or material or component, without departing from the spirit or essential characteristics thereof. Therefore the disclosures and descriptions herein are intended to be illustrative, but not limiting, of the scope of the invention.

What is claimed is:

1. A thermal control system for use with an electric vehicle (EV), said EV comprising a battery pack electrically connected to a propulsion motor, said EV further comprising an on-board thermal management system thermally coupled to said battery pack, said thermal control system comprising:
an auxiliary thermal management system, said auxiliary thermal management system external to and independent of said EV, said auxiliary thermal management system co-located with a battery pack charging system, said auxiliary thermal management system configured to provide supplemental cooling to said battery pack during battery pack charging, said auxiliary thermal management system comprising:
a refrigerant-based thermal control loop, wherein said refrigerant-based thermal control loop utilizes a refrigerant;
a thermal control loop utilizing a thermal transfer fluid and a fluid pump, wherein said thermal transfer fluid is not comprised of said refrigerant, and wherein said fluid pump is configured to circulate said thermal transfer fluid when said thermal control loop is coupled to said battery pack;
a refrigerant-fluid heat exchanger thermally coupled to said refrigerant-based thermal control loop and thermally coupled to said thermal control loop; and
a coupling system configured to temporarily thermally couple said thermal control loop to said battery pack of said EV when said battery pack is coupled to said battery pack charging system.

2. The thermal control system of claim 1, said auxiliary thermal management system further comprising an expansion valve, wherein said expansion valve in a first position decouples said refrigerant-based thermal control loop from said refrigerant-fluid heat exchanger, and wherein said expansion valve in a second position couples said refrigerant-based thermal control loop to said refrigerant-fluid heat exchanger.

3. The thermal control system of claim 2, wherein said expansion valve is adjustable within a range of positions from said first position to said second position, and wherein said range of positions varies a refrigerant flow rate from said refrigerant-based thermal control loop through said refrigerant-fluid heat exchanger.

4. The thermal control system of claim 1, wherein said coupling system connects said thermal control loop to said on-board thermal management system, and wherein said fluid pump circulates said thermal transfer fluid through said thermal control loop and said on-board thermal management system.

5. The thermal control system of claim 4, wherein said coupling system connects said thermal control loop to said on-board thermal management system via a pair of quick-disconnect couplings.

6. The thermal control system of claim 4, wherein said fluid pump is integral to said on-board thermal management system.

7. The thermal control system of claim 4, wherein said fluid pump is integral to said auxiliary thermal management system.

8. The thermal control system of claim 1, wherein said coupling system connects said thermal control loop to a plurality of cooling conduits integrated within said battery pack, and wherein said fluid pump circulates said thermal transfer fluid through said thermal control loop and said plurality of cooling conduits.

9. The thermal control system of claim 8, wherein said coupling system connects said thermal control loop to said plurality of cooling conduits via a pair of quick-disconnect couplings.

10. The thermal control system of claim 8, wherein said fluid pump is integral to said auxiliary thermal management system.

11. The thermal control system of claim 1, said auxiliary thermal management system further comprising an auxiliary thermal management system controller and said on-board thermal management system further comprising a battery management system (BMS) controller, wherein said BMS controller is configured to connect to said auxiliary thermal management system controller when said thermal control loop is thermally coupled to said battery pack.

12. The thermal control system of claim 11, wherein said BMS controller is configured to connect to said auxiliary thermal management system controller via a wireless connection.

13. The thermal control system of claim 11, wherein said BMS controller is configured to connect to said auxiliary thermal management system controller via a wired connection.

14. The thermal control system of claim 11, wherein said auxiliary thermal management system controller is configured to control operation of said auxiliary thermal management system based on data acquired via said BMS controller.

15. The thermal control system of claim 11, wherein said BMS controller is configured to control operation of said auxiliary thermal management system via said auxiliary thermal management system controller.

16. The thermal control system of claim 1, said refrigerant-based thermal control loop further comprising a compressor and a condenser.

17. The thermal control system of claim 16, said auxiliary thermal management system further comprising a blower fan configured to force air through said condenser.

18. The thermal control system of claim 1, said auxiliary thermal management system further comprising a heater coupled to said thermal control loop, said heater configured to heat said thermal transfer fluid within said thermal control loop.

19. The thermal control system of claim 1, wherein said thermal transfer fluid is selected from the group consisting of water and water containing an additive.

20. The thermal control system of claim 19, wherein said additive is selected from the group consisting of ethylene glycol and propylene glycol.
